(19) United States
(12) Patent Application Publication
(10) Pub. No.: US 2022/0186046 A1
(43) Pub. Date: Jun. 16, 2022

(54) LAMINATE AND SURFACE COATING AGENT EXHIBITING LOW GLOSS APPEARANCE

(71) Applicant: 3M INNOVATIVE PROPERTIES COMPANY, St. Paul, MN (US)

(72) Inventors: Naota Sugiyama, Kanagawa (JP); Shinsuke Kondo, Yamagata (JP)

(21) Appl. No.: 17/593,145

(22) PCT Filed: Mar. 25, 2020
(86) PCT No.: PCT/IB2020/052817

§ 371 Date: Sep. 10, 2021

(30) Foreign Application Priority Data
Apr. 16, 2019 (JP) 2019-077851

(51) Int. Cl. C09D 7/42; C09D 7/40; C08J 7/04; C08K 3/36; C08K 9/06; B05D 3/06

(52) U.S. Cl. CPC C09D 7/42; C09D 7/67; C08J 7/0427; C09D 7/70; B05D 2503/00; C08K 9/06; B05D 3/067; C08J 2475/04; B05D 2201/02; C08K 3/36

(57) ABSTRACT

Provided are a laminate and a surface coating agent exhibiting an excellent low gloss appearance. The laminate includes a substrate and a surface layer containing resin beads having an average particle diameter of 4 micrometers or greater and 20 micrometers or less, inorganic nanoparticles, and a binder, wherein the surface layer contains 100 parts by mass or more of the resin beads and the inorganic nanoparticles in total, based on 100 parts by mass of the binder and has a surface glossiness of 6.0 GU or less at 60 degrees.

### TECHNICAL FIELD

The present disclosure relates to a laminate and a surface coating agent exhibiting a low gloss appearance that can be used for optical applications, decorative applications, and the like.

### BACKGROUND ART

For example, in a display device such as a liquid crystal display, a light diffusing sheet is used in order to suppress a decrease in screen visibility. In addition, decorative films and the like embossed for the purpose of decorating interior and exterior of constructions and vehicles are also known.

For example, Patent Document 1 (JP 3743624 B2) discloses a light diffusing sheet including a light diffusion layer formed of a resin film layer having fine irregularities formed on a surface, in which a value of glossiness at 60° (JIS Z8741) of the surface on which the fine irregularities formed is differentiated depending on an incident direction, and a maximum value (a) and a minimum value (b) of the glossiness satisfy a relationship: (a−b)>{(a+b)/2}×0.1.

For example, Patent Document 2 (JP 2011-255552 A) discloses an embossed decorative sheet obtained by embossing a decorative sheet surface, including a surface protective layer formed of a curable resin containing synthetic resin beads on the decorative sheet surface side, in which the embossing has an average amplitude of 15 to 50 micrometers, and the synthetic resin beads are synthetic resin beads having an average particle diameter from 8 to 20 micrometers.

### SUMMARY OF INVENTION

In recent years, for example, a film having a low gloss appearance has been demanded in optical applications and decorative applications. In a case of mechanical means such as embossing, it is necessary to maintain and manage an apparatus such as an embossing roll, which leads to an increase in cost. A technique is also known in which resin beads are blended in the coating agent to roughen the surface of the coating layer, but there are cases in which an excellent low gloss appearance cannot be expressed due to the resin beads precipitated in the coating layer.

The present disclosure provides a laminate and a surface coating agent exhibiting an excellent low gloss appearance.

According to one embodiment, there is provided a laminate that includes a substrate and a surface layer containing resin beads having an average particle diameter of 4 micrometers or more and 20 micrometers or less, inorganic nanoparticles, and a binder, and the surface layer contains 100 parts by mass or greater of the resin beads and the inorganic nanoparticles in total, based on 100 parts by mass of the binder and has a surface glossiness of 6.0 GU or less at 60 degrees.

According to another embodiment, there is provided a surface coating agent containing resin beads having an average particle diameter of 4 micrometers or greater and 20 micrometers or less, inorganic nanoparticles, and a binder precursor, in which the surface layer, which contains 100 parts by mass or greater of the resin beads and the inorganic nanoparticles in total, based on 100 parts by mass of the binder precursor, and is formed by the surface coating agent, exhibits the surface glossiness of 6.0 GU or less at 60 degrees.

According to the present disclosure, it is possible to provide a laminate and a surface coating agent exhibiting an excellent low gloss appearance.

Note that the above description should not be construed to mean that all embodiments of the present invention and all advantages related to the present invention are disclosed.

### BRIEF DESCRIPTION OF DRAWINGS

FIG. 1 is a schematic cross-sectional view of a laminate according to one embodiment of the present disclosure.

FIG. 2A is an SEM photograph of a surface of a surface layer of a laminate according to one embodiment of the present disclosure, and FIG. 2B is an optical micrograph of a cross section of the laminate.

### DESCRIPTION OF EMBODIMENTS

Detailed description will be given for the purpose of exemplifying representative embodiments of the present invention, but the present invention is not limited to these embodiments.

In the present disclosure, “(meth)acryl” means acryl or methacryl, “(meth)acrylate” means acrylate or methacrylate, and “(meth)acryloyl” means “acryloyl” or “methacryloyl.”

In the present disclosure, “low glossiness” means that a surface glossiness on a surface of a certain material or article is 6.0 GU or lower when a measurement angle is 60 degrees. The surface glossiness is determined according to JIS Z8741.

In the present disclosure, “transparent” means that the light transmittance of a material or article in a wavelength range from 400 to 700 nm is 85% or higher; “semi-transparent” means that the light transmittance of a material or article in a wavelength range from 400 to 700 nm is from 20% to less than 85%, and “non-transparent” means that the light transmittance of a material or article in a wavelength range of from 400 to 700 nm is less than 20%. The light transmittance is determined in accordance with ASTM D1003.

In the present disclosure, for example, “on” in “a surface layer disposed on a substrate” means that the surface layer is disposed directly on the substrate, or a surface layer is indirectly disposed above the substrate via another layer.

In one embodiment, a laminate includes a substrate and a surface layer containing resin beads having an average particle diameter of 4 micrometers or more and 20 micrometers or less, inorganic nanoparticles, and a binder, and the surface layer contains 100 parts by mass or more of resin beads and inorganic nanoparticles in total, based on 100 parts by mass of the binder and has a surface glossiness of 6.0 GU or less at 60 degrees. When the surface layer contains a predetermined amount of resin beads having an average particle diameter in the above range and inorganic nanoparticles, a low gloss appearance can be provided.

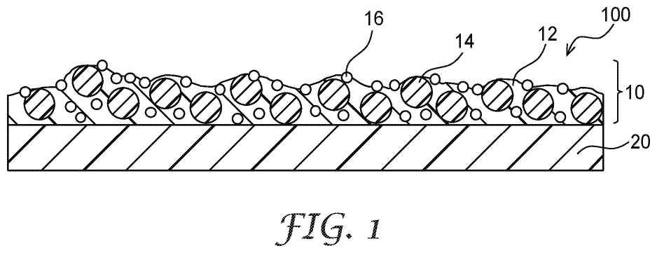

FIG. 1 is a schematic cross-sectional view of a laminate according to one embodiment of the present disclosure. A laminate 100 in FIG. 1 includes a surface layer 10 and a substrate 20. The surface layer 10 contains a binder 12, resin beads 14 having an average particle diameter of 4 micrometers or more and 20 micrometers or less, and inorganic nanoparticles 16.

The binder is not particularly limited, and for example, it can be suitably selected based on the required performance depending on the intended use of the laminate. For example, in optical applications, generally, performance such as hardness and scratch resistance is also required, and thus it is preferable to employ a cured product of ionizing radiation curable compositions known as a hard coat agent, among them, a composition containing an ionizing radiation curable (meth)acrylate monomer or oligomer. In decorative applications, since a laminated film having a surface layer may be elongated, it is preferable to employ a binder having elongation performance, for example, a cured product of a thermosetting or ionizing radiation curable composition containing a urethane component. Hereinafter, a typical binder will be exemplified. When simply described as “curability”, the meaning of such “curability” includes curing performance such as thermosetting and ionizing radiation curability, and the curing performance is appropriately selected depending on the intended use, productivity, and the like.

Examples of the typical binders include resins obtained by polymerizing curable monomers and/or curable oligomers. More specific examples of the resin include a (meth)acrylic resin, a urethane resin, an epoxy resin, a phenol resin, and polyvinyl alcohol. These may be used alone or in combination of two or more of them.

Furthermore, the curable monomer or curable oligomer can be selected from curable monomers or curable oligomers known in the art, a mixture of two or more curable monomers, a mixture of two or more curable oligomers, or a mixture of one or two or more curable monomers and one or two or more curable oligomers may be used.

In some embodiments, examples of the resin include dipentaerythritol pentaacrylate (for example, available as a trade name “SR399” from Sartomer Company, Exton, Pa.), pentaerythritol triacrylate isophorone diisocyanate (IPDI) (for example, available as a trade name “UX-5000” from Nippon Kayaku Co., Ltd. (Tokyo, Japan)), urethane (meth)acrylate (for example, available as trade names “UV1700B” and “UB6300B”) from The Nippon Synthetic Chemical Industry Co., Ltd. (Osaka, Japan), trimethyl hydroxyl diisocyanate/hydroxyethyl acrylate (TMHDI/HEA, for example, available as a trade name “Ebecryl 4858” from Daicel-Cytec Company Ltd (Tokyo, Japan)), polyethylene oxide (PEO) modified bis-A diacrylate (for example, available as a trade name “R551” from Nippon Kayaku Co., Ltd., (Tokyo, Japan)), PEO modified bis-A epoxy acrylate (for example, available as a trade name “3002M” from Kyoeisha Chemical Co., Ltd. (Osaka, Japan)), a silane-based UV curable resin (for example, available as a trade name “SK501M” from Nagase ChemteX Corporation. (Osaka, Japan)), 2-phenoxyethyl methacrylate (for example, available as a trade name “SR340” from Sartomer), and those polymerized using these mixtures.

For example, by using 2-phenoxyethyl methacrylate in the range of 1.0% to 20% by mass, adhesion to polycarbonate or the like can be improved. By using a bifunctional resin (for example, PEO-modified bis-A diacrylate “R551”) and trimethylhydroxyl diisocyanate/hydroxyethyl acrylate (TMHDI/HEA) (for example, available as a trade name “Ebecryl 4858” from Daicel Cytec Co., Ltd.), the hardness, impact resistance, flexibility, and the like of the surface layer after curing can be improved. By using the urethane (meth)acrylate oligomer, the elongation and strength of the surface layer after curing can be improved at the same time. Examples of such urethane (meth)acrylate oligomers include CN964A85, CN964, CN959, CN962, CN963J85, CN965, CN982B88, CN981, CN983, CN991, CN991NS, CN996, CN996NS, CN9002, CN9007, CN9178, and CN9893 from Sartomer Japan Co., Ltd.

In some embodiments, a cured product of an ionizing radiation curable composition having hardness and elongation properties can be used as a binder. As the component that can be used in such a curable composition include, for example, a mixture of a long-chain component (a) having a number average molecular weight of about 200 to 3,000 for imparting the elongation, and a (meth)acrylate component (b) having 3 to 8 (meth)acryloyl groups on average, which increase the crosslinking density to mainly impart the hardness. The balance between the elongation and the hardness can be adjusted by the ratio of (a) to (b).

Examples of the long-chain component (a) include a diisocyanate having an isocyanato group at both ends obtained by reacting aliphatic or alicyclic diols with compounds having two isocyanato groups; and di(meth)acrylates having (meth)acryloyl groups at both ends obtained by reacting the diisocyanate with (meth)acrylates having a dihydroxy group.

Examples of the diols include aliphatic dihydroxy compounds having structures of a straight chain, a branched chain, and an alicyclic ring, having 2 to 10 carbon atoms, polyoxyalkylene glycols such as polyethylene glycol and polypropylene glycol, and oligomers such as polyester diol.

Examples of the aliphatic or alicyclic diisocyanate include aliphatic diisocyanates having from 8 to 15 carbon atoms, such as 1,6-hexamethylene diisocyanate, 2,2,4-trimethylhexamethylene diisocyanate, lysine diisocyanate, isophorone, 4,4′-dicyclohexylmethane diisocyanate, 1,4-cyclohexane diisocyanate, and norbornane diisocyanate.

The (meth)acrylate used for the long-chain component (a) and the (meth)acrylate of the component (b) mean a compound having an acryloyl group or a methacryloyl group. The (meth)acrylate may be any of a monomer, an oligomer, and a prepolymer. The (meth)acrylate may be monofunctional, difunctional or higher polyfunctional, may have a polar group, or may have a low polar molecular structure. Examples of the polar group include a hydroxyl group, a carboxyl group, an amide group, and an amino group, and those having a plurality of one or more polar groups can also be used. For example, the hydroxyl group of (meth)acrylate having a hydroxyl group is suitable for reaction with isocyanate and is used for the preparation of the component (a).

The component (b) preferably has from 3 to 8 (meth)acryloyl groups from the viewpoint of imparting hardness. The component (b) can be used alone or in combination of two or more thereof.

Examples of the molecular structure of the portion to which these (meth)acryloyl groups are bonded include those having at least one kind of a straight chain, a branched chain, an alicyclic ring, or an aromatic ring in the structure, a bond structure of ether, ester, urethane, and amide, and those oligomerized with a silicone chain or the like.

In some embodiments, the binder can be prepared using a non-radical curable resin with radical curable (meth)acrylate. Examples of the radical curable acrylate include fatty acid urethane (for example, available as a trade name “EBECRYL 8701” form Daicel-Allnex, Ltd., Tokyo, Japan). Examples of the non-radical curable resin include a methyl methacrylate copolymer (for example, available as a trade name “B44” from Dow Chemical Company, Midland, Mich.), cellulose acetate butyrate (for example, available as a trade name “CAB 381-2” from Eastman Chemical Company, Kingsport, Tenn.). Such a non-radical curable resin has a function of reducing or preventing agglomeration of resin beads during a drying process and can improve the elongation properties.

As necessary, the binder can be prepared using other curable monomers or curable oligomers. Examples of typical curable monomers or curable oligomers include: (a) compounds having two (meth)acrylic groups such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexanedimethanol diacrylate, alkoxylated hexanediol diacrylate, alkoxylated neopentyl glycol diacrylate, caprolactone modified neopentyl glycol hydroxypivalate diacrylate, caprolactone modified neopentyl glycol hydroxypivalate diacrylate, cyclohexane dimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecane dimethanol diacrylate, triethylene glycol diacrylate, and tripropylene glycol diacrylate; (b) compounds having three (meth)acrylic groups such as glycerol triacrylate, yrimethylolpropane triacrylate, ethoxylated triacrylate (for example, ethoxylated (3) trimethylolpropane triacrylate, ethoxylated (6) trimethylolpropane triacrylate, ethoxylated (9) trimethylolpropane triacrylate, and ethoxylated (20) trimethylolpropane triacrylate), pentaerythritol triacrylate, propoxylated triacrylate (for example, propoxylated (3) glyceryl triacrylate, propoxylated (5.5) glyceryl triacrylate, propoxylated (3) trimethylolpropane triacrylate, and propoxylation (6) trimethylolpropane triacrylate), trimethylolpropane triacrylate, and tris(2-hydroxyethyl) isocyanurate triacrylate; (c) compounds having four or more (meth)acrylic groups such as ditrimethylolpropane tetraacrylate, dipentaerythritol pentaacrylate, ethoxylated (4) pentaerythritol tetraacrylate, pentaerythritol tetraacrylate, and caprolactone-modified dipentaerythritol hexaacrylate; (d) oligomeric (meth)acrylic compounds such as urethane acrylate, polyester acrylate, and epoxy acrylate; polyacrylamide analogue as described above; and polyfunctional (meth)acrylic monomers and polyfunctional (meth)acrylic oligomers selected from the group consisting of these combinations. Such compounds are commercially available, and at least some are available from Sartomer, UCB Chemicals Corporation (Smyrna, Ga.), Aldrich Chemical Company, Milwaukee, WI, and the like. Examples of other useful (meth)acrylates include hydantoin moiety-containing poly (meth)acrylates as reported, for example, in U.S. Pat. No. 4,262,072.

Preferred curable monomers or curable oligomers contain at least three (meth)acrylic groups. Examples of preferred commercially available curable monomers or curable oligomers include trimethylolpropane triacrylate (TMPTA) (trade name “SR351”), pentaerythritol tri/tetraacrylate (PETA) (trade names “SR444” and “SR295”), and dipentaerythritol pentaacrylate (trade name “SR399”) available from Sartomer. Furthermore, a mixture of polyfunctional (meth)acrylate and monofunctional (meth)acrylate, such as a mixture of PETA and 2-phenoxyethyl acrylate (PEA), can also be used.

As necessary, the binder may be prepared using a monofunctional monomer. As monofunctional monomers, for example, cyclic trimethylolpropane formal acrylate (trade name “SR531”) available from Sartomer, monofunctional acrylic monomer (trade name “SR420NS”), cyclic trimethylolpropane formal acrylate (trade name “VISCOAT (trademark) 200”) available from Osaka Organic Chemical Co., Ltd., and 3,3,5-trimethylcyclohexyl acrylate (trade name “VISCOAT (trademark) 196”) can be used.

In some embodiments, a cured product of an ionizing radiation curable composition having the elongation properties can be used as a binder. As the components that can be used in such a curable composition, it is possible to use, for example, at least one selected from the above-described long-chain component (a), urethane (meth)acrylate, and a urethane (meth)acrylate oligomer, the above-described monofunctional component, and a mixture of the functional monomer and the optionally polyfunctional monomer and/or the polyfunctional oligomer described above. The elongation properties can be adjusted by the ratio of each of these components. If the proportion of the polyfunctional component is 5% by mass or less, 3% by mass or less, or 1% by mass or less based on the total weight (solid content) of the mixture of these components, it may exhibit more excellent elongation properties.

The polymerization of the monomer or oligomer is not limited to the following description, and can be performed by, for example, thermal polymerization or photopolymerization. In a case of the thermal polymerization, a thermal polymerization initiator can be used. Although the thermal polymerization initiator is not limited to the following examples, for example, thermal polymerization initiators such as peroxides (for example, potassium peroxodisulfide, ammonium peroxodisulfide) and azo compounds (for example, VA-044, V-50, V-501, and VA-057 (produced by Wako Pure Chemical Industries, Ltd.) can be used. In addition, a radical initiator having a polyethylene oxide chain can also be used. As the catalyst, tertiary amine compounds such as N,N,N′,N′-tetramethylethylenediamine and (β-dimethylaminopropionitrile can be used.

Photopolymerization can be carried out using ionizing radiation such as electron beams and ultraviolet rays. In a case of using the electron beams, it is not necessary to use a photopolymerization initiator, but in the case of the photopolymerization by the ultraviolet rays, the photopolymerization initiator is generally used. Although the photopolymerization initiator is not limited to the following examples, for example, photopolymerization initiators such as IRGACURE (trade name) 2959, DAROCUR (trade name) 1173, DAROCUR (trade name) 1116, IRGACURE (trade name) 184 (available from BASF), QUANTACURE (trade name) ABQ, QUANTACURE (trade name) BT, QUANTACURE (trade name) QTX (available from Shell Chemical Co., Ltd.) and ESACURE ONE (trade name) (available from Lamberti) can be used.

As described above, an ionizing radiation curable composition or a cured product of a thermosetting composition can be used as the binder, and from the viewpoint of reducing or preventing defects such as thermal deformation of the substrate, the ionizing radiation curable composition is preferably used, and the composition containing an ionizing radiation curable (meth)acrylate monomer or oligomer. As a cured product of a thermosetting composition, those other than a thermosetting material of a urethane resin composition described later can also be used.

In some embodiments, the binder can contain the urethane resin. Various known urethane resins can be used as the urethane resin. The urethane resin can be obtained by drying and/or thermosetting a urethane resin composition. The urethane resin composition may be aqueous or non-aqueous. The urethane resin is advantageously a thermosetting material of a two-component urethane resin composition. The two-component urethane resin composition is generally a non-aqueous urethane resin composition. By using the two-component urethane resin composition, other components of the surface layer such as resin beads, inorganic nanoparticles, especially urethane resin beads, and silica nanoparticles form a chemical bond with the urethane resin when the surface layer is formed so that dropping of these particles from the surface layer and bleeding out of the components can be reduced or suppressed.

The two-component urethane resin composition generally contains polyol as a main agent and polyfunctional isocyanate as a curing agent and contains a catalyst and/or a solvent as necessary.

As the polyol, polyester polyol such as polycaprolactone diol and polycaprolactone triol; polycarbonate polyol such as cyclohexanedimethanol carbonate and 1,6-hexanediol carbonate; and a combination of them can be used. These polyols can impart transparency, weather resistance, strength, chemical resistance, and the like to the surface layer. In particular, the polycarbonate polyol can form a surface layer having high transparency and the chemical resistance. From the viewpoint of imparting elongation to the surface layer without forming an excessive cross-linked structure, the polyol is desirably a diol, and polyester diols and polycarbonate diols, particularly polycarbonate diols can be advantageously used.

An OH value of the polyol may be generally 10 mg/KOH or greater, 20 mg/KOH or greater, or 30 mg/KOH or greater, or 150 mg/KOH or less, 130 mg/KOH or less, or 120 mg/KOH or less.

Examples of the polyfunctional isocyanate include aliphatic polyisocyanate, alicyclic polyisocyanate, aromatic polyisocyanate, araliphatic polyisocyanate, and multimers (dimers, trimers, and the like) of these polyisocyanates, biuret-modified products, allophanate-modified products, polyol-modified products, oxadiazine trione-modified products, and carbodiimide-modified products. From the viewpoint of imparting the elongation to the surface layer without forming an excessive crosslinked structure, the polyfunctional isocyanate is desirably diisocyanate. Examples of such diisocyanate include aliphatic diisocyanates such as tetramethylene diisocyanate and hexamethylene diisocyanate (HDI); alicyclic diisocyanates such as isophorone diisocyanate, trans, trans-, trans, cis-, and cis, cis-dicyclohexylmethane-4,4′-diisocyanate and mixtures thereof (hydrogenated MDI); aromatic diisocyanates such as 2,4-tolylene diisocyanate and 2,6-tolylene diisocyanate, and isomer mixtures of these tolylene diisocyanates (TDI), 4,4′-diphenylmethane diisocyanate, 2,4′-diphenylmethane diisocyanate, and 2,2′-diphenylmethane diisocyanate, and isomer mixtures of these diphenylmethane diisocyanates (MDI); and araliphatic diisocyanates such as 1,3- or 1,4-xylylene diisocyanate or mixtures thereof (XDI), 1,3- or 1,4-tetramethylxylylene diisocyanate or mixtures thereof (TMXDI).

An equivalent ratio of polyol to polyisocyanate may be generally 0.6 equivalents or greater or 0.7 equivalents or greater, or 2 equivalents or less or 1.2 equivalents, relative to 1 equivalent of polyol.

As the catalyst, those generally used for forming a urethane resin, for example, di-n-butyltin dilaurate, zinc naphthenate, zinc octenoate, triethylenediamine, and the like can be used. The amount of the catalyst used may be generally 0.005 parts by mass or greater, or 0.01 parts by mass or greater, or 0.5 parts by mass or less or 0.2 parts by mass or less, based on 100 parts by mass of the two-component urethane resin composition.

In some embodiments, the surface layer may further contain cellulose ester. By containing the cellulose ester in the binder, the viscosity of the binder in the drying process can be increased and the surface fluidity can be lowered, so that a coating agent including resin beads can be uniformly applied. The cellulose ester can impart quick-drying property, touch-drying property, flowability, leveling property and the like to the surface coating agent. Examples of the cellulose ester include cellulose acetate propionate and cellulose acetate butyrate.

A number average molecular weight of the cellulose ester can be set to, for example, 12000 g/mol or greater, 16000 g/mol or greater, or 20000 g/mol or greater, and set to be 110000 g/mol or less, 100000 g/mol or less, or 90000 g/mol or less, in consideration of solubility in a solvent. The number average molecular weight is determined by gel permeation chromatography (GPC) using standard polystyrene.

The glass transition temperature (Tg) of the cellulose ester can be set to, for example, 85° C. or higher, 96° C. or higher, or 101° C. or higher, and set to be 190° C. or lower, 180° C. or lower, or 160° C. or lower, in consideration of the shape maintaining property at the use temperature.

In some embodiments, the cellulose ester may be contained in the binder in an amount of 5 parts by mass or greater, 10 parts by mass or greater, or 15 parts by mass or greater, and 35 parts by mass or less, 30 parts by mass or less, or 25 parts by mass or less, based on 100 parts by mass of the binder. By setting the blending amount of the cellulose ester within the above range, the resin beads can be uniformly dispersed by the surface layer, and a uniform low gloss appearance can be imparted to the surface layer.

In some embodiments, the surface layer may further contain a silicone-modified polymer having a functional group capable of reacting with isocyanate or a hydroxyl group. When finger grease adheres to the low gloss surface, the trace is easily observed. By containing a silicone-modified polymer having a functional group capable of reacting with isocyanate or a hydroxyl group in the surface layer, the fingerprint resistance of the surface layer can be improved. The silicone-modified polymer can also impart scratch resistance to the surface layer by reducing the friction coefficient of the surface layer. The silicone-modified polymer may be bonded to the urethane resin or resin beads by reacting, for example, the isocyanate or the hydroxyl group of the silicone-modified polymer with the urethane resin in the binder described above or the hydroxyl group or the isocyanate group of the resin beads described later. In this embodiment, bleeding out of the surface layer of the silicone-modified polymer can be reduced or prevented.

Examples of the silicone-modified polymer having a functional group capable of reacting with isocyanate or a hydroxyl group include silicone-modified polymers such as polyether-modified silicone, polyester-modified silicone, aralkyl-modified silicone, (meth)acryl-modified silicone, silicone-modified poly (meth)acrylate, and urethane-modified silicone. Examples of the functional group capable of reacting with the isocyanate or hydroxyl group of the silicone-modified polymer include a hydroxyl group, an amino group having active hydrogen, an isocyanate group, an epoxy group, and an acid anhydride group. The silicone-modified polymer is advantageously a silicone-modified poly (meth)acrylate from the viewpoint of particularly excellent fingerprint resistance. It is desirable that the silicone-modified polymer has a hydroxyl group or an isocyanate group having a high reactivity with the isocyanate or the hydroxyl group, and particularly has a hydroxyl group.

In some embodiments, the silicone-modified polymer having a functional group capable of reacting with isocyanate or a hydroxyl group, such as silicone-modified poly (meth)acrylate, is 0.1 parts by mass or greater, 0.5 parts by mass or greater, and 1.0 parts by mass or greater, or 15 parts by mass or less, 12 parts by mass or less, or 10 parts by mass or less, based on 100 parts by mass of the binder in the surface layer. By setting the blending amount of the silicone-modified polymer within the above range, the fingerprint resistance and/or scratch resistance of the surface layer can be further improved.

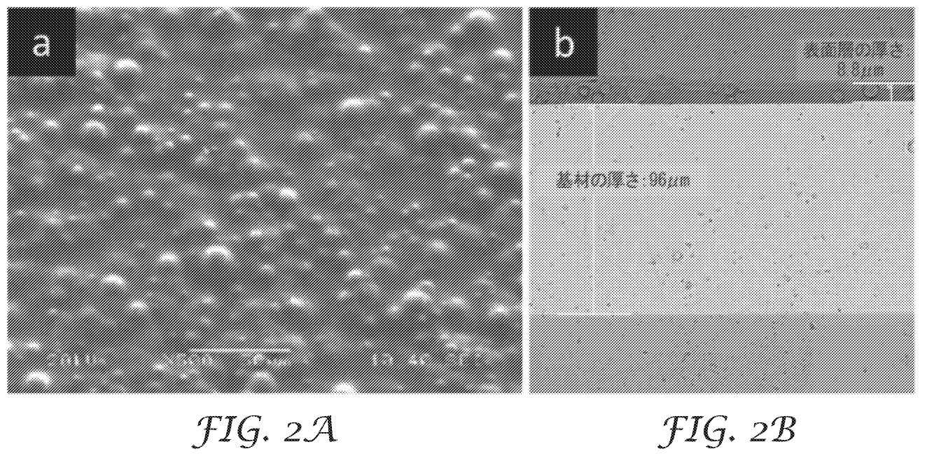

The surface layer of this embodiment contains the resin beads. As illustrated in FIG. 2(a), the resin beads can form a suitable low gloss structure by forming fine irregularities based on the beads on a surface of the surface layer of the laminate.

Examples of the resin beads include resin beads prepared from a styrene resin, a urethane resin, a nylon resin, a polyester resin, a melamine resin, a silicone resin, and a (meth)acrylic resin. Such resin beads may be solid or may have voids and may be used alone or in combination of two or more of them. Among them, urethane resin beads are preferable from the viewpoints of low glossiness and followability when the surface layer is elongated. Here, the urethane resin includes a resin containing a (meth)acrylic component, for example, a resin obtained by polymerizing urethane (meth)acrylate. The surface of the resin beads may be modified with a known surface modifier.

As the urethane resin beads, cross-linked urethane resin beads obtained by suspension polymerization, seed polymerization, emulsion polymerization or the like can be used. Such resin beads are excellent in flexibility, toughness, scratch resistance and the like, and can impart these properties to the surface layer.

When the resin beads and the binder are the same kind of resin components, for example, in a case of resin beads and a binder containing a urethane component, or resin beads and a binder containing a (meth)acrylic component, such resin beads have excellent affinity with the binder, and thus the adhesion with the binder can be improved. As a result, even if the laminate is elongated or deformed, the detachment of the resin beads from the binder can be reduced or suppressed. Here, “the same kind of resin components” are not limited to the fact that the constituent components of the resin are completely the same as each other, and also includes a case where one or more common resin components exist in the components constituting the resin. For example, since the resin beads prepared from urethane acrylate have two kinds of urethane component and acrylic component, it can be said that such resin beads are the same kind of resin components as the urethane resin binder, and the same kind of resin components as the acrylic resin binder.

In addition to the light scattering effect based on the irregularities of the surface of the surface layer, in a case where the light scattering or refraction effect by the resin beads inside the surface layer is also expected, the refractive index of the resin beads is preferably different from the refractive index of the binder.

The average particle diameter of the resin beads is preferably 4 micrometers or more and 20 micrometers or less. In some embodiments, the average particle diameter of the resin beads may be 5 micrometers or greater, 6 micrometers or greater, or 10 micrometers or greater, or may be 10 micrometers or less or 15 micrometers or less. The average particle diameter of the resin beads can be appropriately selected from such a range depending on the intended use. The average particle diameter of the resin beads is a 50% cumulative volume particle diameter measured using a laser diffraction particle size distribution analyzer.

In a case where the average particle diameter of the resin beads is less than 4 micrometers, whitening of the film surface due to the light scattering, that is, an increase in haze is likely to occur. When the average particle diameter of the resin beads exceeds 20 micrometers, gloss tends to occur, and low glossiness is difficult to obtain. Since the resin beads with an average particle diameter in the above range can scatter light incident on the surface layer at a narrow angle, a low gloss with low clarity (transparency) and low whiteness can be imparted to the surface layer. Here, “clarity” is a parameter related to occurrence of focus blurring. For example, in a case where a pattern can be visually recognized when the pattern is confirmed through the laminate, there is no focus blurring, that is, the clarity (transparency) is high, and in a case where the pattern is viewed in a blurred manner, it means that the focus is blurred, that is, the clarity (transparency) is low. Such a decrease in the clarity (transparency) is performance that occurs in a case where light transmitting the laminate is scattered in a narrow angular range and is performance which is different from haze defined as scattering at a wide angle. In a case where the light having transmitted the laminate is scattered at a wide angle, the amount of light reaching the viewer's eyes is reduced, but the light scattered at a wide angle does not reach the eyes, so that the focus is rarely blurred. On the other hand, in a case where the light having transmitted the laminate is scattered at a narrow angle (small angle), most of the light reaches the eyes with a slight shift, so the reduction in the amount of light that reaches the eyes is small, but it is visually recognized in a blurred state. In other words, higher haze does not necessarily mean lower clarity. For example, in a case where the haze is high and the clarity is high, when the pattern is confirmed through the laminate, the pattern becomes white as a whole, and the pattern can be visually recognized without blurring.

In some embodiments, in consideration of the whitening, low glossiness, clarity, extensibility, hardness, scratch resistance, or the like of the surface layer, the resin beads can be 35 parts by mass or greater, 40 parts by mass or greater, 50 parts by mass or greater, 60 parts by mass or greater, 70 parts by mass or greater, 80 parts by mass or greater, or 100 parts by mass or greater, and 240 parts by mass or less, 230 parts by mass or less, 200 parts by mass or less, 180 parts by mass or less, 150 parts by mass or less, 120 parts by mass or less, 100 parts by mass or less, or 80 parts by mass or less, based on 100 parts by mass of the binder in the surface layer. The blending amount of the resin beads can be appropriately selected from such a range depending on the intended use. For example, in a case where the laminate is used for the decorative applications, the resin beads are preferably used in the range from 100 to 240 parts by mass. Since the laminate may be used by being stretched for the decorative applications, the surface layer containing a relatively large amount of resin beads can easily follow such elongation. In a case where the laminate is used for the optical applications, the resin beads are preferably used in the range of 35 to 80 parts by mass. In the optical applications, the hardness and the scratch resistance of the surface layer may also be required, and thus the surface layer containing a relatively low amount of soft resin beads compared to inorganic particles can reduce or prevent a decrease in the hardness and the scratch resistance.

The surface layer of this embodiment further contains the inorganic nanoparticles. In a case where a coating agent containing only the resin beads is applied to the substrate, the resin beads tend to precipitate inside the coating layer (surface layer), but in a case where a coating agent containing the resin beads and the inorganic nanoparticles was used, both the resin beads and the inorganic nanoparticles tend to be uniformly dispersed in the coating layer. This is considered that in the case of the coating agent containing the resin beads and the inorganic nanoparticles, the resin beads are prevented from precipitating by causing a sudden increase in viscosity after coating. As described above, the surface layer of the present disclosure can be prevented from precipitating the resin beads by using the inorganic nanoparticles in combination even though relatively large resin beads are used, and can cause the resin beads to remain near the surface, and therefore, it can be considered that an irregularity structure can be imparted to the surface of the surface layer. In addition, since the laminate of the present disclosure can impart the irregularity structure to the surface of the surface layer without blending a large amount of relatively soft resin beads to the surface layer, it is also possible to improve performance such as the hardness and scratch resistance of the surface layer.

Due to the presence of the inorganic nanoparticles in the binder, it is possible to effectively reduce or prevent whitening of the laminate by suppressing changes in low glossiness that tends to occur in a case where the laminate is stretched with only the resin beads.

The inorganic nanoparticles are not particularly limited. For example, at least one kind of particle chosen from silica, alumina, titanium oxide, zinc oxide, zirconium oxide, tin dope indium oxide, and antimony dope tin oxide can be used. Among these, silica nanoparticles are preferable. As silica nanoparticles, for example, silica sol obtained using water glass (sodium silicate solution) as a starting material can be used.

Commercially available products can be used as the inorganic nanoparticles. For example, NALCO (trade name) 2327, 2329 (available from Nalco) as silica particles; BIRAL (trade name) AL-A7 (available from Taki Chemical Co., Ltd.) as alumina particles; TTO-51 (A) (available from ISHIHARA SANGYO KAISHA, LTD.) as titanium oxide particles; NANOBYK (trade name) 3820 (available from BYK) as zinc oxide particles; BIRAL (trade name) Zr-20 (available from Taki Chemical Co., Ltd.) as zirconium oxide; PI-3 (produced by Mitsubishi Materials Electronic Chemicals Co., Ltd.) as dope indium oxide; and 549541 (available from Sigma-Aldrich Co. LLC) as antimony dope tin oxide can be used.

The surface of the inorganic nanoparticle may be modified with a surface treatment agent such as silane, alcohol, amine, carboxylic acid, sulfonic acid, phosphonic acid, and titanate.

In some embodiments, the average particle diameter of the inorganic nanoparticles can be 10 nm or greater, 20 nm or greater, 30 nm or greater, or 40 nm or greater, or can be 100 nm or less, 90 nm or less, 80 nm or less, 75 nm or less, 60 nm or less, or 45 nm or less. The average particle diameter of the inorganic nanoparticles can be appropriately selected from such a range depending on the intended use. The average particle diameter of the inorganic nanoparticles is an average value of particle diameters of 10 or greater, for example, from 10 to 100 particles measured using TEM.

By using the inorganic nanoparticles having such a minute size, the inorganic nanoparticles can be highly dispersed in the surface layer. As a result, the precipitate of the resin beads in the coating layer can be reduced or suppressed. Further, even if the laminate is stretched, the minute inorganic nanoparticles remain dispersed in the stretched portion, so that the loss of low gloss can be suppressed, and the whitening of the film can be effectively reduced or prevented. It is also possible that the inorganic nanoparticles present adjacent to the resin beads serve as a kind of physical cross-linking point between the resin beads and the binder. It is considered that the presence of such inorganic nanoparticles that can act as a physical cross-linking point suppresses the precipitate of the resin beads and facilitates the development of low glossiness, and also prevents the resin beads from falling off when the laminate is elongated, and the whitening of the laminate can be effectively reduced or prevented.

In some embodiments, in consideration of the whitening, low glossiness, clarity, extensibility, hardness, scratch resistance, or the like of the surface layer, the inorganic nanoparticles can be 5 parts by mass or greater, 10 parts by mass or greater, 20 parts by mass or greater, 30 parts by mass or greater, 40 parts by mass or greater, 50 parts by mass or greater, 70 parts by mass or greater, 85 parts by mass or greater, or 100 parts by mass or greater, and 250 parts by mass or less, 230 parts by mass or less, 200 parts by mass or less, 170 parts by mass or less, 150 parts by mass or less, 120 parts by mass or less, 110 parts by mass or less, 100 parts by mass or less, 90 parts by mass or less, or 80 parts by mass or less, based on 100 parts by mass of the binder in the surface layer. The blending amount of the inorganic nanoparticles can be appropriately selected from such a range depending on the intended use. For example, in a case where the laminate is used for the decorative applications, the inorganic nanoparticles are preferably used in the range of 5 to 100 parts by mass. In decorative applications, the laminate may be used in an elongated state, but the surface layer containing inorganic nanoparticles at such a proportion maintains a low gloss appearance even when the laminate is elongated, for example, whitening can be reduced or prevented at 150% elongation in a case where the original length of the laminate is 100%. In a case where the laminate is used for the optical applications, the inorganic nanoparticles are preferably used in the range of 70 to 250 parts by mass. The surface layer containing the inorganic nanoparticles at such a proportion can impart low glossiness having low whiteness with low clarity (transparency) and can also improve the surface hardness and the scratch resistance.

The surface layer of this embodiment preferably contains 100 parts by mass or more of the resin beads and the inorganic nanoparticles described above in total, based on 100 parts by mass of the binder. In some embodiments, the resin beads and the inorganic nanoparticles can be 120 parts by mass or greater, 150 parts by mass or greater, or 170 parts by mass or greater, and can be 900 parts by mass or less, 800 parts by mass or less, 700 parts by mass or less, 600 parts by mass or less, 500 parts by mass or less, 400 parts by mass or less, 350 parts by mass or less, 300 parts by mass or less, or 250 parts by mass or less in total, based on 100 parts by mass of the binder. When the total amount of the resin beads and the inorganic nanoparticles is such a proportion, a surface layer exhibiting an excellent low gloss appearance can be provided.

As other optional components, the surface layer may include additives such as fillers other than resin beads and inorganic nanoparticles, flakes, wood chips, fibers, grass, straw, salt, pepper, sugar, green laver, diorama powder, a UV absorber, a light stabilizer, a heat stabilizer, a dispersant, a plasticizer, a flow improver, a leveling agent, a pigment, dyes, and fragrances. These additives may be dispersed in the surface layer or may be sprinkled on the surface layer to be disposed only in the vicinity of the surface. For example, in a case where the laminate is used for the decorative applications, when applying flakes, woodchips, fibers, grass, straw, salt, pepper, sugar, green laver, diorama powder, and the like to the surface of the surface layer, a unique texture can be provided. The individual amount and the total amounts of these additives can be determined within a range that does not impair the properties required for the surface layer.

The surface coating agent of this embodiment for forming the surface layer can contain various materials that can be used in the above-described surface layer, and has the resin beads having an average particle diameter of at least 4 micrometers or more and 20 micrometers or less, inorganic nanoparticles, and a binder precursor. Here, the binder precursor means a component that finally becomes a binder in the surface layer, and examples thereof include a curable monomer and/or a curable oligomer, a resin obtained by curing them in advance, and non-curable resins such as the above-described methyl methacrylate copolymer and cellulose acetate butyrate.

The blending of the surface coating agent is as described for the surface layer. Regarding the above-described blending amounts of various materials such as resin beads and inorganic nanoparticles, as a standard, 100 parts by mass of the binder is read as 100 parts by mass of the binder precursor and applied in a case where the materials are contained in the form of a binder precursor, a curable monomer, or a curable oligomer in the coating agent.

In order to improve workability, coating properties, and the like, the surface coating agent further contains solvents such as ketones such as methyl ethyl ketone, methyl isobutyl ketone, and acetyl acetone, aromatic hydrocarbons such as toluene and xylene, alcohols such as ethanol, isopropyl alcohol, 1-methoxy-2-propanol, esters such as ethyl acetate and butyl acetate, ethers such as tetrahydrofuran, propylene glycol monomethyl ether, propylene glycol monomethyl ether acetate (1-methoxy-2-propyl acetate) and dipropylene glycol monomethyl ether acetate. A blending amount of the solvents in the surface coating agent can be generally 20 parts by mass or greater or 30 parts by mass or greater and can be 60 parts by mass or less or 50 parts by mass or less, based on 100 parts by mass of the binder precursor.

The viscosity of the surface coating agent can generally be 20 mPa·s or greater, 50 mPa·s or greater, or 100 mPa·s or greater, and can be 1000 mPa·s or less, 800 mPa·s or less, or 600 mPa·s or less. A viscosity of the surface coating agent is measured by selecting an appropriate spindle using a B-type viscometer at a rotating rate of 60 rpm.

The surface layer can be formed by applying the surface coating agent on a substrate by knife coating, bar coating, blade coating, doctor coating, roll coating, cast coating, or the like, and is dried and/or thermally cured or ionizing radiation cured as necessary.

A thickness of the surface layer can be, for example, 3 micrometers or greater, 4 micrometers or greater, 5 micrometers or greater, 6 micrometers or greater, 8 micrometers or greater, or 10 micrometers or greater, and can be 50 micrometers or less, 30 micrometer or less, 20 micrometers or less, 15 micrometers or less, or 10 micrometers or less. The thickness of the surface layer can be appropriately selected from such a range depending on the intended use. For example, in a case where the laminate is used for the optical applications, it may require hardness and scratch resistance of the surface layer in addition to low glossiness, and thus it is advantageous to increase the thickness of the surface layer to be 6 micrometers or more, or 8 micrometers or more. Here, the thickness of the surface layer in the present disclosure means the thickness of the thickest portion, that is, the maximum thickness. The maximum thickness is determined from the average value of values measured at 5 or more locations, preferably 10 locations, using a micrometer (model number: ID-C112XB) available from Mitutoyo Corporation in accordance with JIS K6783.

The surface layer of the present disclosure contains the resin beads having an average particle diameter from 4 to 20 micrometers. In a case where the thickness of the surface layer is larger than the average particle diameter of the resin beads, the resin beads generally tend to be precipitated and embedded in the surface layer, so that it is difficult to impart irregularities associated with the resin beads to the surface of the surface layer. Since the surface layer of the present disclosure contains a predetermined amount of such resin beads and inorganic nanoparticles, the inorganic nanoparticles can reduce or suppress the precipitate of the resin beads. As a result, even if the thickness of the surface layer is larger than the average particle diameter of the resin beads, the resin beads can remain on the surface of the surface layer, and thus it is possible to impart an irregularity structure to the surface of the surface layer, and to obtain the effect of improving the hardness or scratch resistance of the surface layer.

The substrate is not particularly limited, and examples thereof include an organic substrate containing at least one selected from the group consisting of a polyvinyl chloride resin, a polyurethane resin, a polyolefin resin, a polyester resin, a vinyl chloride-vinyl acetate resin, a polycarbonate resin, a (meth)acrylic resin, a cellulose resin, and a fluorine resin. As the substrate, an inorganic substrate such as glass or a metal substrate such as aluminum can be used.

The shape or configuration of the substrate is not particularly limited, and may be, for example, a film shape, a plate shape, a curved surface shape, a different shape, or a three-dimensional shape, and a single layer configuration, a laminated configuration, or a composite configuration in which a plurality of substrates having different shapes.

The substrate may be colored or colorless. The substrate may be non-transparent, semi-transparent, or transparent. The substrate may have a substantially smooth surface or may have a structured surface that can be formed by surface processing such as embossing.

In one embodiment, the substrate may include a transparent resin layer and a colored resin layer, such as a transparent polyvinyl chloride resin layer and a colored polyvinyl chloride resin layer. In the laminate of this embodiment, since the colored resin layer is supported or protected by the transparent resin layer, durability can be imparted to the decorativeness of the laminate. The laminate film from this aspect can be suitably used, for example, for application to the interior or exterior of a building or vehicle.

The thickness of the substrate can be 25 micrometers or greater, 50 micrometers or greater, or 80 micrometers or greater, for example, and can be 5 mm or less, 1 mm or less, or 0.5 mm or less.

In some embodiments, a substrate capable of being elongated can be used as the substrate. A tensile elongation rate of the substrate capable of being elongated can be 10% or greater, 20% or greater, or 30% or greater, and can be 400% or less, 350% or less, or 300% or less. The tensile elongation rate of the substrate capable of being elongated is a value calculated as [chuck spacing at break (mm)—chuck spacing before elongation (mm) (=100 mm)]/chuck spacing before elongation (mm) (=100 mm)×100 (%), when a sample having a width of 25 mm and a length of 150 mm is prepared and the sample is elongated at a temperature of 20° C., a tensile speed of 300 mm/min, and a chuck spacing of 100 mm using a tensile tester until the sample is broken.

In some embodiments, the laminate of this embodiment may optionally apply additional layers such as a colored layer, a decorative layer, a conductive layer, a primer layer, and an adhesive layer, for example, between the surface layer and the substrate, or on the substrate surface opposite the surface layer.

The adhesive layer may use a commonly used acrylic, polyolefin, polyurethane, polyester, or rubber-based solvent type, emulsion type, pressure sensitive type, thermal type, thermosetting type, or ultraviolet curing type adhesive. The thickness of the release liner adhesive layer can be, generally, 5 micrometers or more, 10 micrometers or more, or 20 micrometers or more, and can be 100 micrometers or less, 80 micrometers or less, or 50 micrometers or less.

A liner may be applied to the surface of the adhesive layer. Examples of liners include paper; plastic materials such as polyethylene, polypropylene, polyester and cellulose acetate; and papers coated with such plastic materials. These liners may have surfaces release-treated with silicone or the like. The thickness of the liner can be, generally, 5 micrometers or more, 15 micrometers or more, or 25 micrometers or more, and can be 500 micrometers or less, 300 micrometers or less, or 250 micrometers or less.

The laminate of this embodiment may be, for example, a single-wafer product, a roll body wound in a roll shape, or an article having a three-dimensional shape.

The surface glossiness of the surface layer of the laminate of the present disclosure is 6.0 GU or less when the measurement angle is 60 degrees. In some embodiments, such surface glossiness can be 5.5 GU or less, 5.0 GU or less, or 4.5 GU or less at a measurement angle of 60 degrees. The lower limit of the surface glossiness at a measurement angle of 60 degree is not particularly limited, and for example, it can be 1.0 GU or greater or 1.5 GU or more. In some embodiments, the surface glossiness of the surface layer of the laminate can be 1.5 GU or less, 1.0 GU or less, 0.60 GU or less, or 0.50 GU or less at a measurement angle of 20 degrees. The lower limit of the surface glossiness at a measurement angle of 20 degree is not particularly limited, and for example, it can be 0.10 GU or greater or 0.15 GU or greater. In some embodiments, the surface glossiness of the surface layer of the laminate can be 10.0 GU or less, 9.0 GU or less, 8.0 GU or less, or 7.0 GU or less at a measurement angle of 85 degrees. The lower limit of the surface glossiness at a measurement angle of 85 degree is not particularly limited, and for example, it can be 1.0 GU or more or 1.2 GU or more. Here, the surface glossiness is measured using a portable gloss meter BYK Gardner Micro-Tri-Gloss (BYK-Chemie GmbH, Shinjuku-ku, Tokyo, Japan) in accordance with JIS Z8741.

In one embodiment, the surface glossiness in the surface layer of the laminate is 1.5 GU or less at a measurement angle of 20 degrees, 6.0 GU or less at a measurement angle of 60 degrees, and 10.0 GU or less at a measurement angle of 85 degrees. In some embodiments, the surface glossiness of the surface layer of the laminate is 1.0 GU or less at 20 degrees, 5.5 GU or less at 60 degrees, 9.0 GU or less at 85 degrees, or 0.8 GU or less at 20 degrees, 5.0 GU or less at 60 degrees, and 8.0 GU or less at 85 degrees. When the surface glossiness of the laminate is a combination of the above ranges, for example, in a case where the laminate is used for the decorative applications, it is possible to reduce or suppress reflection of light incident on the laminate at various angles. Therefore, the decoration of the laminate can be recognized from a wide viewing angle. Since the laminate having such surface glossiness and the ability to transmit light can reduce clarity, in a case of being used for the optical applications, for example, used as a light diffusing member of a liquid crystal display, visibility such as RGB grid lines and LED appearance can be reduced or suppressed.

In some embodiments, the laminate may be transparent or semi-transparent. In these embodiments, the light transmittance of the laminate in the wavelength range from 400 to 700 nm can be 80% or greater, 85% or greater, or 90% or greater. The upper limit of the light transmittance is not particularly limited, and for example, it can be 99% or less, 98% or less, 97% or less, or 96% or less. When the laminate has such light transmittance, for example, in a case where the laminate is used for the optical applications such as a light diffusing member, a decrease in luminance from a light source can be reduced or prevented. Here, the light transmittance is measured using Haze-Gard Plus (available from BYK) in accordance with ASTM D1003.

In some embodiments, the laminate of the present disclosure can be evaluated by haze. An initial haze value of the laminate can be 76% or greater, 78% or greater, 80% or greater, or 82% or greater. The upper limit of the initial haze value is not particularly limited, and for example, it can be 92% or less, 90% or less, or 88% or less. When the laminate has such haze value, for example, in a case where the laminate is used for the optical applications such as a light diffusing member, light from the light source can be suitably diffused. Here, the haze is measured using Haze-Gard Plus (available from BYK) in accordance with ASTM D1003.

In some embodiments, the laminate of the present disclosure can be evaluated by clarity (transparency). The clarity of the laminate can be 50% or less, 40% or less, 30% or less, or 20% or less. A lower limit of the clarity is not particularly limited, and for example, it can be 5.0% or greater, 6.0% or greater, or 7.0% or greater. When the laminate has such clarity, for example, in a case where it is used as a light diffusing member (for example, a light diffusing film or an anti-glare (AG) film) of a liquid crystal display, visibility such as RGB grid lines and the appearance of the LED, which are inconvenient for the viewer, can be reduced or suppressed. Here, the clarity is measured using Haze-Gard Plus (available from BYK) in accordance with ASTM D1003.

In some embodiments, the laminate may have excellent surface hardness or scratch resistance. In these embodiments, the surface hardness of the laminate can be evaluated by pencil hardness, can be HB or more or F or more, and can be 3H or less, 2H or less, or H or less. Here, in accordance with JIS K5600-5-4, the pencil hardness means the pencil hardness when fixing a sample of the laminate on a glass plate and scratching the surface of the sample at a speed of 600 mm/min with a load of 750 g applied to a tip of a pencil core.

The scratch resistance of the laminate can be evaluated by a steel wool abrasion test. This test is conducted by polishing the surface of the surface layer of the laminate 10 times (cycle) with 27 mm square # 0000 by using a steel wool abrasion tester (rubbing tester IMC-157C, available from Imoto machinery Co., LTD) under the conditions of steel wool, 350 g load, 85 mm stroke, at a speed of 60 cycles/minute, and evaluated by Δ haze value (haze value after abrasion test—initial haze value) based on the above-described haze measurement. The Δhaze value of the laminate can be −2.0% to 2.0%, −1.5% to 1.5%, or −1.0% to 1.0%.

In some embodiments, the brightness L* of the laminate is 23 or less, 22.5 or less, or 22.0 or less when measured using a spectrocolorimeter at light source D65/10°, specular treatment SCI, and 0% UV reflection.

In some embodiments, in a case where the laminate has elongation, the brightness before elongation of the laminate is L*₁, the brightness after 150% elongation is L*₂, and when a difference in brightness is ΔL*=L*₂−L*₁, a brightness difference ΔL* is 3.0 or less, 2.5 or less, or 2.0 or less. In this embodiment, the whitening when the laminate is elongated is suppressed. Therefore, for example, in a case where the laminate is used for the decorative applications, when the laminate is bent or elongated and applied to the surface, the decorativeness of the laminate can be maintained even in a bent portion or an elongation portion.

The application of the laminate of the present disclosure is not particularly limited. For example, the laminate of the present disclosure can be used for the decorative applications, the optical applications, or the like. For example, the laminate of the present disclosure can be used as an interior material such as a wall, a staircase, a ceiling, a pillar, or a partition of constructions such as a building, an apartment, or a house, or an exterior material such as an outer wall, can be used as the interior or exterior of various transportation vehicles such as rail vehicles, ships, airplanes, automobiles including two-wheels and four-wheels, and can also be used as a covering material for all articles such as road signs, signboards, furniture, and electrical appliances. Furthermore, the laminate of the present disclosure can be used as, for example, a light diffusing member used in a display device such as a liquid crystal display or an organic EL display device, such as a light diffusing film or a light diffusing plate for ensuring uniformity of luminance of a backlight, or an anti-glare (AG) film or the like for reducing or preventing reflection of light from a fluorescent lamp.

### EXAMPLES

Specific embodiments of the present disclosure are exemplified in the following examples, but the present invention is not limited to these embodiments. All parts and percentages are based on mass, unless otherwise stated. The numerical value essentially includes errors due to a measurement principle and a measurement device. The numerical value is indicated by a significant number that has undergone a normal rounding treatment.

Table 1 indicates materials, reagents and the like used in this example.

TABLE 1

| | Trade name, model | |
|---|---|---|
| number or abbreviation | Description | Provider |
| ARTPEARL (trade | Urethane resin beads, average particle | Negami Chemical |
| name) CE-800T | diameter of 6 micrometers | Industrial Co., Ltd (Nomi |
| | | City, Ishikawa Prefecture, |
| | | Japan) |
| ARTPEARL (trade | Urethane acrylate resin beads, average | Negami Chemical |
| name) UA-806 | particle diameter of 6 micrometers | Industrial Co., Ltd (Nomi |
| | | City, Ishikawa Prefecture, |
| | | Japan) |
| ARTPEARL (trade | Urethane resin beads, average particle | Negami Chemical |
| name) C-600 | diameter of 10 micrometers | Industrial Co., Ltd (Nomi |
| | | City, Ishikawa Prefecture, |
| | | Japan) |
| ARTPEARL (trade | Urethane resin beads, average particle | Negami Chemical |
| name) CE-400T | diameter of 15 micrometers | Industrial Co., Ltd (Nomi |
| | | City, Ishikawa Prefecture, |
| | | Japan) |
| ARTPEARL (trade | Urethane resin beads, average particle | Negami Chemical |
| name) C-400 | diameter of 15 micrometers | Industrial Co., Ltd (Nomi |
| | | City, Ishikawa Prefecture, |
| | | Japan) |
| ARTPEARL (trade | Urethane resin beads, average particle | Negami Chemical |
| name) C-300 | diameter of 22 micrometers | Industrial Co., Ltd (Nomi |
| | | City, Ishikawa Prefecture, |
| | | Japan) |
| SILQUEST (trade | Silane coupling agent: 3- | Alfa Aesar (USA) |
| name) A-174 | methacryloxypropyltrimethoxysilane | |
| PROSTAB (trade | 4-hydroxy-2,2,6,6-tetramethylpiperidine- | Aldrich Chemical |
| name) | 1-oxyl, solid content of 5% by mass | Company (USA) |
| NALCO (trade name) | Unmodified SiO₂ sol, average particle | Nalco Company (USA) |
| 2329 | diameter of 75 nm | |
| CN991NS | Curing oligomer: Aliphatic polyester | Arkema Group (USA) |
| | urethane diacrylate oligomer | |
| CN996NS | Curing oligomer: Aliphatic urethane | Arkema Group (USA) |
| | diacrylate oligomer | |
| SR531 | Curing monomer: Cyclic | Arkema Group (USA) |
| | trimethylolpropane formal acrylate | |
| SR444N5 | Curing monomer: Pentaerythritol | Arkema Group (USA) |
| | triacrylate | |
| SR833 | Curing monomer: Tricyclodecane | Arkema Group (USA) |
| | dimethanol diacrylate | |
| EBECRYL (trade | Curing monomer: Aliphatic urethane | Daicel-Allnex Ltd. (Chuo- |
| name) 8701 | triacrylate | ku, Tokyo, Japan) |
| CAB-381-2 | Cellulose acetate butyrate | Eastman Chemical |
| | | Company (USA) |
| B44 | Polyme thylmethacrylate | Dow Chemical Company |
| | | (USA) |
| TEGO (trade name) | Acrylic polydimethylsiloxane | EVONIK INDUSTRIES |
| Rad 2250 | | (Germany) |
| Irgacure (trade name) | Photopolymerization initiator: Phenyl (1- | BASF Japan Ltd. (Minato- |
| 184 | hydroxycyclohexyl) methanone | ku, Tokyo, Japan) |
| ESACURE (trade | Photopolymerization initiator: | Lamberti (Italy) |
| name) ONE | Bifunctional α-hydroxyketone | |
| MIPA | 1-methoxy-2-propanol | Fujifilm Wako Pure |
| | | Chemical Corporation |
| | | (Chuo-ku, Osaka, Japan) |
| MIBK | Methyl isobutyl ketone | Fujifilm Wako Pure |
| | | Chemical Corporation |
| | | (Chuo-ku, Osaka, Japan) |
| IPA | 2-propanol | Fujifilm Wako Pure |
| | | Chemical Corporation |
| | | (Chuo-ku, Osaka, Japan) |
| PCLR#100 | Polycarbonate sheet having a thickness | KEIWA Incorporated |
| | of 100 micrometer | (Chuo-ku, Tokyo, Japan) |
| Sabic Gen I PC | Diffusion sheet | SABIC (Saudi Arabia) |
| Keiwa LH PC | Diffusion sheet | KEIWA Incorporated |
| | | (Chuo-ku, Tokyo, Japan) |

### Preparation of Modified Silica Sol

5.95 g SILQUEST (trade name) A-174 and 0.5 g PROSTAB (trade name) were added to a mixture of 400 g NALCO (trade name) 2329 and 450 g MIPA in a glass bottle and stirred for 10 minutes at room temperature. The glass bottle was sealed and left in an oven at 80° C. for 16 hours. Water was removed from the obtained solution using a rotary evaporator at 60° C. until the solid content of the solution was close to 45% by mass. 200 g of MIPA was added to the obtained solution, and then the remaining water was removed using a rotary evaporator at 60° C. The latter step was repeated twice to remove more water from the solution. Finally, the concentration of all SiO₂ nanoparticles is adjusted to 47.5% by mass by adding MIPA, and a SiO₂ sol (hereinafter, referred to as a modified silica sol) containing surface-modified SiO₂ nanoparticles having an average particle diameter of 75 nm.

### Preparation of Coating Agent 1

2.4 g CN991NS, 1.6 g CN996NS, 3.2 g SR531, and 0.8 g SR833 were mixed. 0.08 g of

Irgacure 184 as a photopolymerization initiator and 0.016 g of TEGO (trade name) Rad 2250 were added to the mixture. Next, 12.00 g of IPA was added to the mixture to prepare a coating Agent 1.

### Preparation of Coating Agent 2

16.0 g ARTPEARL (trade name) CE-800T, 4.48 g EBECRYL (trade name) 8701, and 1.6 g SR833 were mixed. 0.24 g ESACURE (trade name) ONE, 0.016 g TEGO (trade name) Rad 2250 and 0.32 g CAB-381-2 as a photopolymerization initiator were added to the mixture. Next, 12.00 g of MIPA was added to the mixture to prepare coating agent 2.

### Preparation of Coating Agents 3 to 17

Coating agents 3 to 17 were prepared in the same manner as coating agent 2 except that the blending ratios indicated in Tables 2 to 3 below were adopted. In addition, all the blending amounts in Table 2 and Table 3 are indicated by parts by mass.

TABLE 2

| Composition | | Coating agent | | | | | | | | |
|---|---|---|---|---|---|---|---|---|---|---|
| Resin beads | ARTPEARL (trade name) | 1 | 2 | 3 | 4 | 5 | 6 | 7 | 8 | 9 |
| | CE-800T, average | | | | | | | | | |
| | particle diameter of 6 μm | | | | | | | | | |
| | ARTPEARL (trade name) | — | 1.600 | 1.600 | 1.600 | 1.600 | 1.600 | — | 0.800 | 0.400 |
| | UA-806, average | | | | | | | | | |
| | particle diameter of 6 μm | | | | | | | | | |
| | ARTPEARL (trade name) | — | — | — | — | — | — | 1.600 | — | — |
| | C-600, average | | | | | | | | | |
| | particle diameter of 10 μm | | | | | | | | | |
| | ARTPEARL (trade name) | — | — | — | — | — | — | — | — | — |
| | CE-400T, average | | | | | | | | | |
| | particle diameter of 15 μm | | | | | | | | | |
| | ARTPEARL (trade name) | — | — | — | — | — | — | — | — | — |
| | C-400, average | | | | | | | | | |
| | particle diameter of 15 μm | | | | | | | | | |
| | ARTPEARL (trade name) | — | — | — | — | — | — | — | — | — |
| | C-300, average | | | | | | | | | |
| | particle diameter of 22 μm | | | | | | | | | |
| Inorganic | Modified silica sol | — | — | 2.021 | 5.389 | 6.737 | 8.084 | 6.737 | 7.579 | 8,000 |
| nanoparticles | (average particle diameter | | | | | | | | | |
| | of 75 nm, solid content | | | | | | | | | |
| | of 47.5% by mass) | | | | | | | | | |
| Binder | CN991NS | 2.400 | — | — | — | — | — | — | — | — |
| precursor | CN996NS | 1.600 | — | — | — | — | — | — | — | — |
| | SR531 | 3.200 | — | — | — | — | — | — | — | — |
| | SR444NS | — | — | 1.088 | 0.768 | 0.640 | 0.512 | 0.640 | 0.720 | 0.760 |
| | SR833 | 0.800 | 1.600 | 0.816 | 0.768 | 0.640 | 0.512 | 0.640 | 0.720 | 0.760 |
| | EBECRYL (trade name) | — | 4.480 | 3.264 | 2.304 | 1.600 | 1.280 | 1.600 | 1.800 | 1,900 |
| | 8701 | | | | | | | | | |
| | B44 | — | — | 0.272 | 0.192 | 0.320 | 0.256 | 0.320 | 0.360 | 0.380 |
| | CAB-381-2 | — | 0.320 | — | — | — | — | — | — | — |
| Photo- | Irgacure (trade name) 184 | 0.080 | — | — | — | — | — | — | — | — |
| polymerization | ESACURE (trade name) | — | 0.240 | 0.240 | 0.240 | 0.240 | 0.240 | 0.240 | 0.240 | 0.240 |
| initiator | ONE | | | | | | | | | |
| Leveling | TEGO (trade name) | 0.016 | 0.016 | 0.016 | 0.016 | 0.016 | 0.016 | 0.016 | 0.016 | 0.016 |
| agent | Rad 2250 | | | | | | | | | |
| Diluent | IPA | 12.000 | — | — | — | — | — | — | — | — |
| | MIPA | — | 12.000 | 8.539 | 6.771 | 6.063 | 5.356 | 6.063 | 5.621 | 5,400 |
| | MIBK | — | — | 2.400 | 2.400 | 2.400 | 2.400 | 2.400 | 2.400 | 2,400 |

| | | | | | | | | | |
|---|---|---|---|---|---|---|---|---|---|
| Content of resin beads based on 100 parts | — | 25.0 | 29.4 | 41.7 | 50.0 | 62.5 | 50.0 | 22.2 | 10.5 |
| by mass of binder precursor | | | | | | | | | |
| Content of inorganic nanoparticles based | — | — | 17.6 | 66.7 | 100.0 | 150.0 | 100.0 | 100.0 | 100.0 |
| on 100 parts by mass of binder precursor | | | | | | | | | |

TABLE 3

| Composition | | Coating agent | | | | | | | |
|---|---|---|---|---|---|---|---|---|---|
| Resin beads | ARTPEARL (trade name) | 10 | 11 | 12 | 13 | 14 | 15 | 16 | 17 |
| | CE-800T, average particle | | | | | | | | |
| | diameter of 6 μm | | | | | | | | |
| | ARTPEARL (trade name) | 0.800 | 0.400 | 1.200 | — | — | — | — | — |
| | UA-806, average particle | | | | | | | | |
| | diameter of 6 μm | | | | | | | | |
| | ARTPEARL (trade name) | — | — | — | — | — | — | — | — |
| | C-600, average particle | | | | | | | | |
| | diameter of 10 μm | | | | | | | | |
| | ARTPEARL (trade name) | — | — | — | 1.600 | — | — | — | — |
| | CE-400T, average particle | | | | | | | | |
| | diameter of 15 μm | | | | | | | | |
| | ARTPEARL (trade name) | — | — | — | — | — | 1.600 | — | — |
| | C-400, average particle | | | | | | | | |
| | diameter of 15 μm | | | | | | | | |
| | ARTPEARL (trade name) | — | — | — | — | — | — | 1.600 | — |
| | C-300, average particle | | | | | | | | |
| | diameter of 22 μm | | | | | | | | |
| Inorganic | Modified silica sol (average | 9.095 | 9.600 | 7.158 | 6.737 | 6.737 | 6.737 | 6.737 | 6,316 |
| nanoparticles | particle diameter of 75 nm, | | | | | | | | |
| | solid content of 47.5% by | | | | | | | | |
| | mass) | | | | | | | | |
| Binder | CN991NS | — | — | — | — | — | — | — | 1,800 |
| precursor | CN996NS | — | — | — | — | — | — | — | 0.600 |
| | SR531 | — | — | — | — | — | — | — | 1,350 |
| | SR444NS | 0.576 | 0.608 | 0.680 | 0.640 | 0.640 | 0.640 | 0.640 | — |
| | SR833 | 0.576 | 0.608 | 0.680 | 0.640 | 0.640 | 0.640 | 0.640 | — |
| | EBECRYL (trade name) | 1.440 | 1.520 | 1.700 | 1.600 | 1.600 | 1.600 | 1.600 | — |
| | 8701 | | | | | | | | |
| | B44 | 0.288 | 0.304 | 0.340 | 0.320 | 0.320 | 0.320 | 0.320 | — |
| | CAB-381-2 | — | — | — | — | — | — | — | 0.150 |
| Photo- | Irgacure (trade name) 184 | — | — | — | — | — | — | — | — |
| polymerization | ESACURE (trade name) | 0.240 | 0.240 | 0.240 | 0.240 | 0.240 | 0.240 | 0.240 | 0.240 |
| initiator | ONE | | | | | | | | |
| Leveling agent | TEGO (trade name) | 0.016 | 0.016 | 0.016 | 0.016 | 0.016 | 0.016 | 0.016 | 0.016 |
| | Rad 2250 | | | | | | | | |
| Diluent | IPA | — | — | — | — | — | — | — | — |
| | MIPA | 4.825 | 4.560 | 5.842 | 6.063 | 6.063 | 6.063 | 6.063 | 6,284 |
| | MIBK | 2.400 | 2.400 | 2.400 | 2.400 | 2.400 | 2.400 | 2.400 | 2,400 |

| | | | | | | | | |
|---|---|---|---|---|---|---|---|---|
| Content of resin beads based on 100 | 27.8 | 13.2 | 35.3 | 50.0 | 50.0 | 50.0 | 50.0 | 51.3 |
| parts by mass of binder precursor | | | | | | | | |
| Content of inorganic nanoparticles based | 150.0 | 150.0 | 100.0 | 100.0 | 100.0 | 100.0 | 100.0 | 76.9 |
| on 100 parts by mass of binder precursor | | | | | | | | |

### Example 1

Using a # 20 Meyer rod, the coating agent 5 was applied onto a substrate (PCLR # 100) to form a coating layer having a thickness from 8 to 12 micrometers. After drying at 60° C. for 5 minutes in an air atmosphere, the substrate to which the coating layer was applied was subjected to an ultraviolet irradiator (H-bulb (DRS model) of Fusion UV System Inc.) was passed twice to cure the coating layer. At this time, the coating layer was irradiated with ultraviolet rays (UV-A) under the conditions of an illuminance of 700 mW/cm² and an integrated light amount of 900 mJ/cm². In this way, a laminate having a coating layer having a thickness of about 12 to about 15 micrometers was produced.

### Examples 2 to 8

Laminates of Examples 2 to 8 were produced in the same manner as Example 1 except that the coating agents shown in Tables 4 and 5 were used.

### Comparative Example 1

A commercially available Sabic Gen I PC, which is a diffusion sheet, was used.

### Comparative Example 2

A commercially available Keiwa LH PC, which is a diffusion sheet, was used.

### Comparative Example 3

Commercially available PCLR # 100 used as a substrate was used.

### Comparative Examples 4 to 12

Laminates of Comparative Examples 4 to 12 were produced in the same manner as Example 1 except that the coating agents shown in Tables 4 and 5 were used.

The following evaluations were performed on the samples of Examples 1 to 8 and Comparative Examples 1 to 12, and the results are indicated in Tables 4 and 5.

### Surface Glossiness

The surface glossiness of each sample was measured at each measurement angle of 20°, 60°, and 85° using a portable gloss meter BYK Gardner Micro-Tri-Gloss (BYK-Chemie GmbH) in accordance with JIS Z8741.

### Optical Properties in Visible Light Region

The optical properties of each sample were measured using Haze-Gard Plus (BYK) according to ASTM D1003. Here, as the optical properties, light transmittance, haze, and clarity (transparency) in the visible light region (wavelength 400 to 700 nm) were evaluated.

### Surface Hardness

In accordance with JIS K5600-5-4, the surface hardness was evaluated from the pencil hardness measured by fixing a sample of the laminate on a glass plate, and scratching the surface of the sample at a speed of 600 mm/min with a load of 750 g applied to a tip of a pencil core.

### Scratch Resistance

The scratch resistance of each sample was evaluated by the change in the optical properties after the steel wool abrasion test. This test is conducted by polishing the surface layer of each sample 10 times (cycle) with 27 mm square #0000 by using an abrasion tester (rubbing tester IMC-157C, available from Imoto machinery Co., LTD) under the conditions of steel wool, 350 g load, 85 mm stroke, at a speed of 60 cycles/minute. In the same manner as the optical properties described above, the light transmittance, haze, clarity, and Δhaze (haze after abrasion test—initial haze) in the visible light region (wavelength from 400 to 700 nm) with respect to the sample after polishing were evaluated.

TABLE 4

| | | | Comparative | Comparative | Comparative | Comparative | Comparative |
|---|---|---|---|---|---|---|---|
| | | | Example 1 | Example 2 | Example 3 | Example 4 | Example 5 |
| Coating agent | | | — | — | — | 1 | 2 |
| Initial | Surface | 20 degrees | 1.3 | 3.1 | 21.3 | 76.6 | 8.3 |
| properties | glossiness | 60 degrees | 12.6 | 18.6 | 106.0 | 98.4 | 47.6 |
| | (GU) | 85 degrees | 36.4 | 42.2 | 97.2 | 92.6 | 56.5 |
| | Optical | Light | 92.00 | 92.30 | 92.00 | 93.00 | 92.50 |
| | properties | transmittance (%) | | | | | |
| | | Haze (%) | 77.80 | 45.10 | 0.30 | 0.69 | 19.10 |
| | | Clarity (%) | 11.00 | 26.70 | 92.00 | 99.00 | 63.70 |
| | Pencil hardness | | 2B | 3B | 3B | — | F |
| Properties | Optical | Light | 92.00 | 92.10 | 91.80 | 92.90 | 92.90 |
| after | properties | transmittance (%) | | | | | |
| abrasion | | Haze (%) | 77.70 | 51.50 | 7.65 | 4.93 | 8.40 |
| test | | Clarity (%) | 11.50 | 24.50 | 99.20 | 98.70 | 64.60 |
| | | ΔHaze (%) | −0.10 | 6.40 | 7.35 | 4.24 | −10.70 |
| | | | Comparative | Comparative | Example | | |
| | | | Example 6 | Example 7 | 1 | Example 2 | Example 3 |
| Coating agent | | | 3 | 4 | 5 | 6 | 7 |
| Initial | Surface | 20 degrees | 14.7 | 2.0 | 0.50 | 0.30 | 0.40 |
| properties | glossiness | 60 degrees | 56.4 | 13.9 | 4.00 | 2.80 | 3.20 |
| | (GU) | 85 degrees | 69.8 | 23.4 | 8.20 | 1.60 | 7.00 |
| | Optical | Light | 93.00 | 92.00 | 91.70 | 92.40 | 92.60 |
| | properties | transmittance (%) | | | | | |
| | | Haze (%) | 11.90 | 43.70 | 80.00 | 87.20 | 85.10 |
| | | Clarity (%) | 55.60 | 25.20 | 9.70 | 12.00 | 8.80 |
| | Pencil hardness | | — | HB | F | F | F |
| Properties | Optical | Light | 93.00 | 92.60 | 92.50 | 92.40 | 92.70 |
| after | properties | transmittance (%) | | | | | |
| abrasion | | Haze (%) | 6.63 | 46.90 | 79.20 | 86.60 | 84.60 |
| test | | Clarity (%) | 67.00 | 21.50 | 9.00 | 11.30 | 8.20 |
| | | ΔHaze (%) | −5.27 | 3.20 | −0.80 | −0.60 | −0.50 |

TABLE 5

| | | | Comparative | Comparative | Comparative | Comparative | Example |
|---|---|---|---|---|---|---|---|
| | | | Example 8 | Example 9 | Example 10 | Example 11 | 4 |
| Coating agent | | | 8 | 9 | 10 | 11 | 12 |
| Initial | Surface | 20 degrees | 2.50 | 5.40 | 3.40 | 7.80 | 0.60 |
| properties | glossiness | 60 degrees | 14.60 | 36.20 | 16.30 | 34.80 | 4.30 |
| | (GU) | 85 degrees | 21.70 | 47.70 | 24.90 | 35.20 | 7.40 |
| | Optical | Light | 92.50 | 92.70 | 92.50 | 92.70 | 92.50 |
| | properties | transmittance (%) | | | | | |
| | | Haze (%) | 44.50 | 23.40 | 44.40 | 29.60 | 75.70 |
| | | Clarity (%) | 34.70 | 63.00 | 45.40 | 75.10 | 27.10 |
| | Pencil hardness | | HB | HB | B | HB | F |
| Properties | Optical | Light | 92.60 | 92.60 | 92.40 | 92.50 | 92.60 |
| after | properties | transmittance (%) | | | | | |
| abrasion | | Haze (%) | 46.40 | 22.80 | 45.00 | 30.60 | 76.50 |
| test | | Clarity (%) | 38.50 | 64.20 | 42.70 | 73.00 | 20.20 |
| | | ΔHaze (%) | 1.90 | −0.60 | 0.60 | 1.00 | 0.80 |
| | | | Example | Example | Example | Comparative | Example |
| | | | 5 | 6 | 7 | Example 12 | 8 |
| Coating agent | | | 13 | 14 | 15 | 16 | 17 |
| Initial | Surface | 20 degrees | 0.60 | 0.4 | 1.1 | 1.8 | 0.3 |
| properties | glossiness | 60 degrees | 4.0 | 2.7 | 5.1 | 8.4 | 3.4 |
| | (GU) | 85 degrees | 2.7 | 2.5 | 1.8 | 1.4 | 9.6 |
| | Optical | Light | 92.90 | 95.40 | 95.40 | 95.20 | 95.20 |
| | properties | transmittance (%) | | | | | |
| | | Haze (%) | 80.10 | 87.70 | 82.70 | 75.70 | 83.40 |
| | | Clarity (%) | 28.60 | 37.00 | 44.10 | 48.20 | 9.70 |
| | Pencil hardness | | HB | HB | HB | HB | HB |
| Properties | Optical | Light | 90.90 | 93.90 | 92.40 | 92.60 | 92.40 |
| after | properties | transmittance (%) | | | | | |
| abrasion | | Haze (%) | 82.50 | 89.40 | 82.10 | 70.30 | 82.10 |
| test | | Clarity (%) | 28.10 | 29.70 | 43.20 | 50.10 | 16.70 |
| | | ΔHaze (%) | 2.40 | 1.70 | −0.60 | −5.40 | −1.30 |

It will be apparent to those skilled in the art that various modifications can be made to the embodiments and the examples described above without departing from the principles of the present invention. In addition, it will be apparent to those skilled in the art that various improvements and modifications of the present invention can be carried out without departing from the gist and the scope of the present invention.

### REFERENCE SIGNS LIST

100 Laminate

10 Surface layer

12 Binder

14 Resin bead

16 Inorganic nanoparticle

20 Substrate

1. A laminate comprising:
a substrate; and
a surface layer containing resin beads having an average particle diameter of 4 micrometers or greater and 20 micrometers or less, inorganic nanoparticles, and a binder,
wherein the surface layer contains 35 parts by mass or greater and 80 parts by mass or less of the resin beads and 70 parts by mass or greater and 250 parts by mass or less of the inorganic nanoparticles, based on 100 parts by mass of the binder, and has a surface glossiness of 6.0 GU or less at 60 degrees.

2. The laminate according to claim 1, wherein the inorganic nanoparticles have the average particle diameter of 10 nm or greater and 100 nm or less.

3. The laminate according to claim 1, wherein the binder contains a cured product of an ionizing radiation curable composition.

4. The laminate according to claim 1, wherein the surface layer has a surface glossiness of 1.5 GU or less at 20 degrees, 6.0 GU or less at 60 degrees, and 10.0 GU or less at 85 degrees.

5. The laminate according to claim 1, wherein the substrate is colored or colorless, non-transparent, semi-transparent, or transparent, and has a substantially smooth surface or a structured surface.

6. The laminate according to claim 1, wherein the substrate contains at least one selected from the group consisting of a polyvinyl chloride resin, a polyurethane resin, a polyolefin resin, a polyester resin, a vinyl chloride-vinyl acetate resin, a polycarbonate resin, a (meth)acrylic resin, a cellulose resin, and a fluorine resin.

7. The laminate according to claim 1, wherein the laminate is used for optical applications.

8. (canceled)

9. The laminate according to claim 1, wherein a thickness of the surface layer is 3 micrometers or greater.

10. The laminate according to claim 1, wherein the thickness of the surface layer is larger than the average particle diameter of the resin beads and has a pencil hardness of HB or more.

11. The laminate according to claim 1, wherein when a brightness before elongation of the laminate is L*₁, a brightness after 150% elongation is L^{*}2, and a difference in brightness is ΔL*=L*₂−L*₁, the brightness difference ΔL* is 3.0 or less.

12. A surface coating agent comprising:
resin beads having an average particle diameter of 4 micrometers or greater and 20 micrometers or less;
inorganic nanoparticles; and
a binder precursor,
wherein the surface layer, which contains 35 parts by mass or greater and 80 parts by mass or less of the resin beads and 70 parts by mass or greater and 250 parts by mass or less of the inorganic nanoparticles, based on 100 parts by mass of the binder precursor, and is formed by a coating agent, exhibits a surface glossiness of 6.0 GU or less at 60 degrees.
